(19) United States
(12) Patent Application Publication
(10) Pub. No.: US 2017/0363775 A1
(43) Pub. Date: Dec. 21, 2017

(54) SYSTEM FOR MEASURING RAIN AND SNOW

(71) Applicants: Jose Luis RAMIREZ ARIAS, Bogota (CO); UNIVERSIDAD COOPERATIVA DE COLOMBIA, Bogota (CO)

(72) Inventor: Jose Luis RAMIREZ ARIAS, Bogota (CO)

(21) Appl. No.: 15/541,195

(22) PCT Filed: Dec. 30, 2014
(86) PCT No.: PCT/IB2014/067430

§ 371 Date: Jul. 28, 2017

(51) Int. Cl. G01W 1/14; H05B 3/18; G01F 23/292

(52) U.S. Cl. CPC G01W 1/14; G01F 23/292; H05B 3/18

(57) ABSTRACT

The invention relates to a device for measuring rain and snow, comprising: a module for collecting water or snow; a module for measuring the level and volume of fluid; an information processing module; a heating module for collecting snow; a frame; and a photovoltaic energy module.

### TECHNOLOGICAL FIELD

The present invention relates to a system or device for measuring rain and snow, consisting in a module for collecting water or level, a module for measuring the level and volume of fluid, a data processing module, a heating module for collecting snow, a housing, and a photovoltaic energy module.

The device for measuring rain and snow permits the determination of the levels of rainwater or of snow in a given geographical zone, being adapted to the particular conditions of the place whereat said measurement is made, such as the atmospheric pressure and the temperature; this is realized by virtue of the data processing module which, making use of artificial intelligence, is capable of adapting the functioning of the device for measuring rain and snow to the particular conditions of the zone. The device is autonomous from an energy point of view by virtue of the fact that it utilizes photovoltaic solar energy for the functioning thereof.

The device of the present invention may be utilized for measurements at different levels, from environmental applications to aeronautical applications, by virtue of the pressure provided thereby based on the principle of operation thereof.

### BACKGROUND OF THE INVENTION

In the present day the majority of devices for measuring rain, or pluviometers, utilize as operating principal the cumulative measurement of the quantity of water falling upon a rocker and, based upon the number of times that the rocker tips, the quantity of water having ingressed into the system is calculated; however, these types of application do not take into account phenomena such as evaporation and changes of temperature and pressure which may affect the instantaneous measurement and the historical record of the precipitation data.

For example, the patent described in the U.S. Pat. No. 3,229,519 relates to a pluviometer comprising an open vessel for the collection of precipitation, having liquid in the interior, principally connected with said vessel to record the volume of the liquid therein contained, a generally horizontal body of said vessel is principally immersed in said liquid, for rotation thereof upon a substantially horizontal axis; in this manner the precipitation may be communicated with the interior of said vessel, the internal body of the liquid and the surface level of same.

The foregoing system is solely valid for the measurement of substantial quantity of rain, said measurement being realized by counting the number of turns produced by the falling of liquid into the device; on realizing the measurement in this manner the precision is not high, by virtue of the fact that the minimum measurement corresponds to the quantity of water which the cylinder succeeds in ingressing within the oil, limiting the upper and lower level of the measurement in terms of the quantity of rain.

Additionally, the device is based upon considering that, firstly, the temperature of evaporation of the oil and, secondly, the surface tension of the oil are constant properties of same; nevertheless it is known in the state of the art that said properties change as a function of the temperature and the pressure, from which it may be deduced that the measurement would change as a function of the location of said device.

Additionally, the invention U.S. Pat. No. 4,665,743 reveals a pluviometer comprising a first vessel to receive the dry precipitation, a second vessel to receive the wet precipitation, provided with a first sensor capable of emitting a signal when a certain volume of sample of wet precipitation has been collected, a closing device permitting the alternate closure of the two vessels as a function of a signal emitted by a precipitation detector, a measuring device located in the outlet from the second vessel, utilized to undertake the measurements of the physicochemical quantities of the sample, a sampling device located in an outlet of the measuring device, used to dispose and maintain a fraction of each sample at a temperature below 0°, and a system of verification automatically controlling the foregoing components as a function of the signals emitted by the sensors.

The system for measuring of said invention is related to the saturation of the container, considerably limiting the precision of the system; in the same manner it is related with the storage of the samples, this being unfit for the object of the application. Moreover, the system lacks communications and a system permitting the processing of the data in an intelligent manner.

Another development is described in the patent CN101813793 disclosing a pluviometer of the digital control type, comprising a receiver for water, a test cylinder in communication with the receiver for water and a sensor disposed in the test cylinder utilized to measure the water level data, wherein the upper extremity of the sensor is connected with a reference test rod and is in connection with a pulley of a pull cord.

The system proposed in said invention lacks an exact measurement of the quantity of rain by virtue of the fact that the measurement depends upon rigid and fixed mechanical elements, limiting the range of operation and measurement. In the same manner, the system does not consider the heating of the sample to attain the appropriate temperature for the measurement.

The invention WO2013098437 relates to a pluviometer providing a measurement of the precipitations, wherein the components or parts of the pluviometer have been designed such as to maximally reduce the errors produced by meteorological factors, essentially the wind, and the errors produced by instrumental or operational factors, wherein the pluviometer comprises an upper rain collector, receiving means of the rainwater collected in the collector and upon each emptying activating a device recording data of the intensity and quantity of water precipitated, a heating device, a lower measuring cylinder whereinto the receiving means empty, a lower storage vessel for the water collected, and a support structure possessing level positioning.

By virtue of the functioning principle of said system, it requires an operator to take the measurement as a function of the level shown in a test cylinder. Furthermore, the system is not automatic, it is not intelligent, and it presents no possibilities of calibration, by virtue whereof it is not exact.

In this respect, it is clear that it is necessary to develop new devices achieving the resolution of the technical problems related with the manner wherein the sample of rain or snow is collected, the processing to which the sample is subjected to ensure the precision of the measurement, and the utilization of different types of sensors permitting validation of the data obtained; furthermore, these instruments are of great assistance in aeronautical applications by virtue of the fact that they permit the obtainment of data on the conditions of rain in airports, for which purpose it is necessary to have available devices permitting the obtainment of data in real time without the requirement for anyone being present at the site whereat the measurement is taken.

Moreover, it is evident that there exists in the state of the art the need to design and implement a system or device for measuring rain which may be calibrated in conformity with the particular conditions of the site of operation and provided with artificial intelligence in order to optimize the functioning of the device and the quality of the measurement.

In this sense, one of the advantages of the present application stems from the fact that that the device referred to is capable of measuring any quantity of precipitation of rain or snow, by virtue of the fact that it does not utilize cumulative measurements as do the majority of conventional sensors of this type. Another advantage of the present invention stems from the use of a remote sensor and a flow sensor to calculate the volume of fluid collected. This measurement is stored over time to constitute a digital record of the behavior of the precipitation. Furthermore, the device of the present invention utilizes the principles of fluid mechanics to optimize the process of measurement.

In this respect, one of the novel contributions possessed by the system or device in conformity with the present invention is that it possesses an adaptive control module maintaining the temperature of the sample at an appropriate level, according to the site of operation, in order to ensure the quality of the measurement.

In effect, the present invention is of great importance by virtue of the fact that it permits substantial improvement of the measurement of the precipitation of water or snow, said measurement being of immense importance in aeronautical applications to improve the safety of operations of taking off and landing of aircraft.

In addition to the foregoing, the present invention renders a significant contribution to the state of the art by virtue of the fact that, disposing of a device capable of being adapted to the particular conditions of the zone, it ensures the quality of the measurement.

The function of the system in conformity with the present invention has as objective to measure and record the quantity of precipitation of rain or snow in an adaptive and intelligent manner.

### DESCRIPTION OF THE DRAWINGS

The invention may be better understood by means of the drawings wherein there are shown each of the elements comprising the device for measuring rain and snow, the protection whereof is desired. Furthermore, the drawings indicate the reference numbers assigned to the elements constituting said system.

FIG. 1 corresponds to the external configuration of the system for measuring rain and snow in conformity with the present invention, wherein there is detailed a constitution of the modules comprising the system, these being a module for collecting water or snow (1) and the housing (5).

FIG. 2 corresponds to a cutaway view showing the internal configuration of the system or device for measuring rain and snow, wherein there are detailed a housing (5) and photovoltaic energy module (6), comprising a panel (61), a regulator (62), a battery (63), and an enclosure (64). The housing (5) possesses a funnel (11), an impurities filter (12), a laser sensor (21), laser sensors (23), a U-shaped bottle (25), flow sensor (27), embedded system (31), liquid crystal or LED touch screen (32), a conical support for the resistance (42).

FIG. 3 corresponds to a view of the components within the housing (5) of the module for collecting water or snow (1), wherein there may be observed a module for measuring the level and volume of fluid (2), a heating module for collecting snow (4), and the base of the housing (5).

FIG. 4 corresponds to an exploded view of the module for collecting water or snow (1), a module for measuring the level and volume of fluid (2), a heating module for collecting snow (4), a housing (5).

FIG. 5 corresponds to an exploded view of the module for collecting water or snow (1), comprising a funnel (11), an impurities filter (12) and a gasket (13).

FIG. 6A corresponds to an exploded view of the heating module for collecting snow (4) wherein the following elements are detailed: a conical resistance (41), a conical support for the resistance (42), a thermocouple temperature sensor (43).

FIG. 6B corresponds to a cutaway isometric view of the heating module for collecting snow (4), wherein the following elements are detailed: a conical resistance (41), a conical support for the resistance (42), a thermocouple temperature sensor (43).

FIG. 7 corresponds to an exploded view of a module for measuring the level and volume of fluid (2), comprising a laser sensor (21), a laser sensor base (22), three supports for the laser sensor (23), three fixing rings for supports (24), a U-shaped bottle (25), a coupling for flow sensor (26), a flow sensor (27), a flow sensor outlet elbow (28), a drain tube (29), a protective filter for the drain (30).

FIG. 8 corresponds to a cutaway view wherein there are detailed the orifice of the U-shaped bottle (25) of the module for measuring the level and volume of fluid (2).

FIG. 9 corresponds to frontal and upper views of the laser sensor base (22).

FIG. 10 corresponds to an exploded view of the housing (5), comprising a cover (51), a door (52), a pin (53) for the door (52), a locking device (54), two military connectors (55) and a base (56).

FIG. 11A corresponds to a detailed view of the base (56) of the housing (5).

FIG. 11B corresponds to a detailed longitudinal cutaway view of the base (56) of the housing (5).

FIG. 12 corresponds to the photovoltaic energy module (6), comprising a panel (61), a regulator (62), a battery (63), and an enclosure (64).

FIG. 13 corresponds to the data processing module (3), comprising an embedded system (31), a digital interface for display upon a liquid crystal or LED touch screen (32), an RS-232 communications interface and an Ethernet 10/100/1000 communications interface located within the embedded system (31).

FIG. 14 corresponds to a functional diagram of the device for measuring rain precipitation and snow.

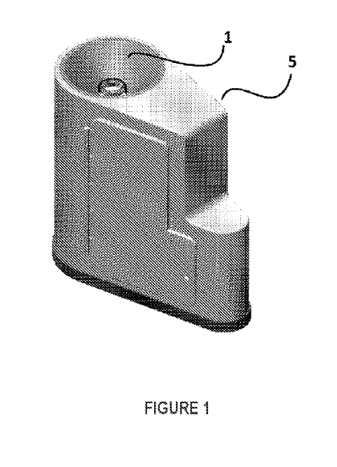

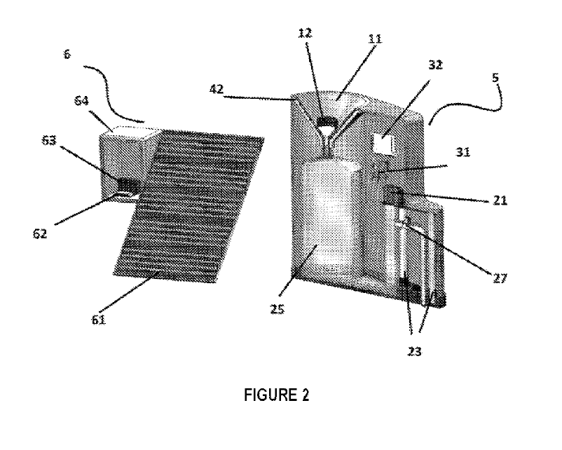

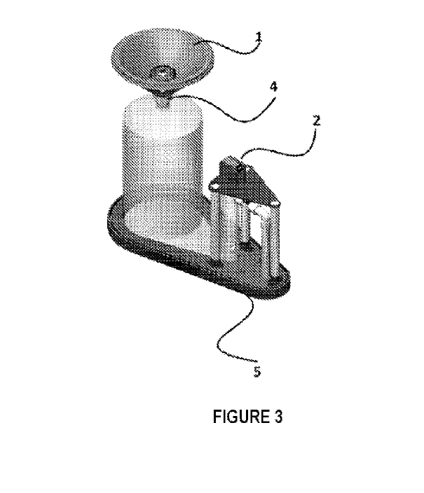

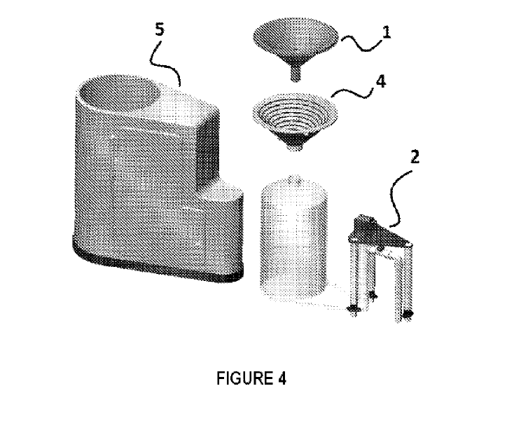

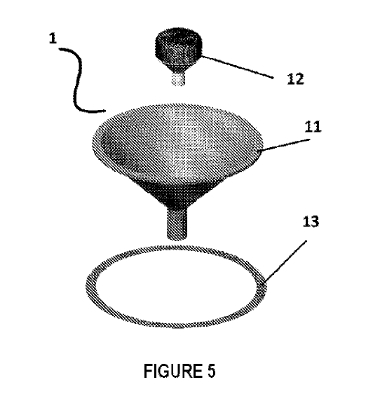

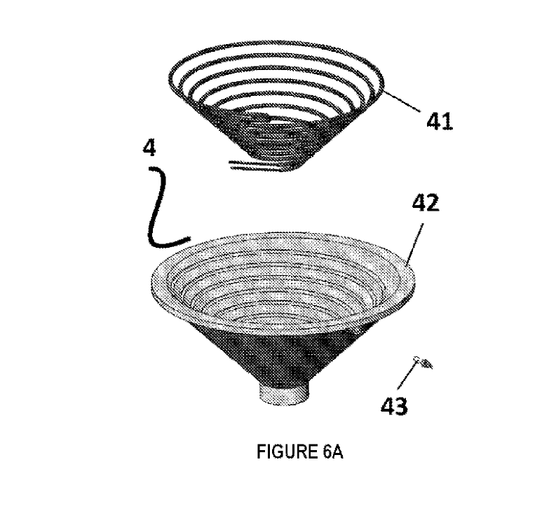

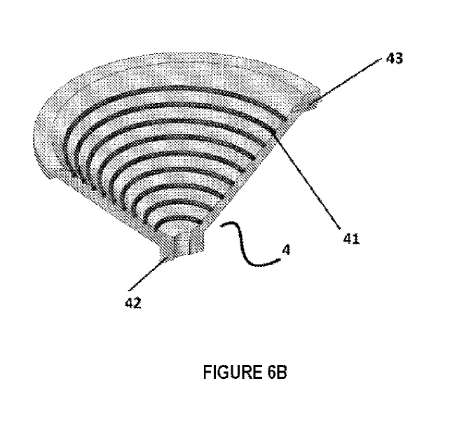

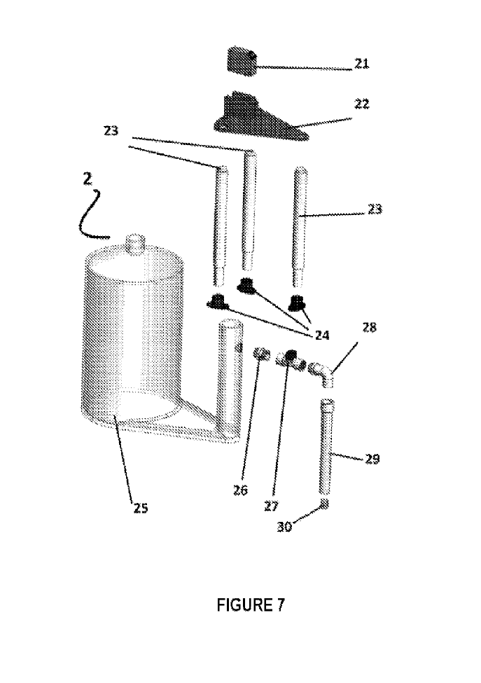

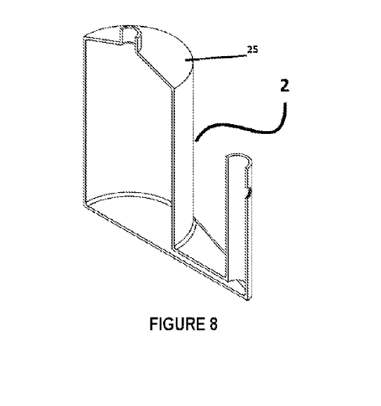

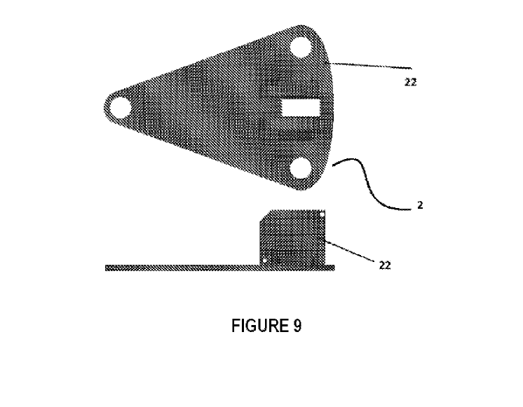

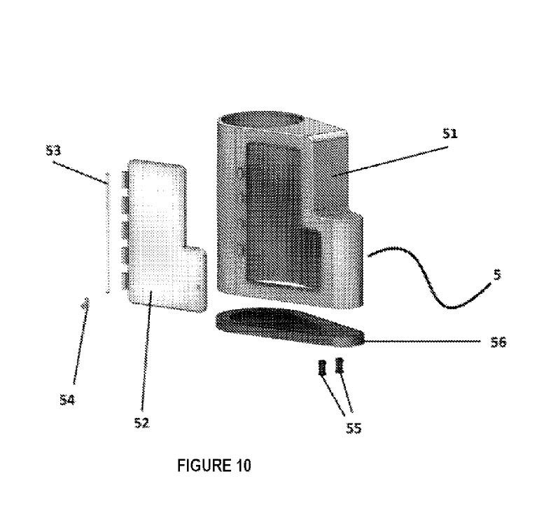

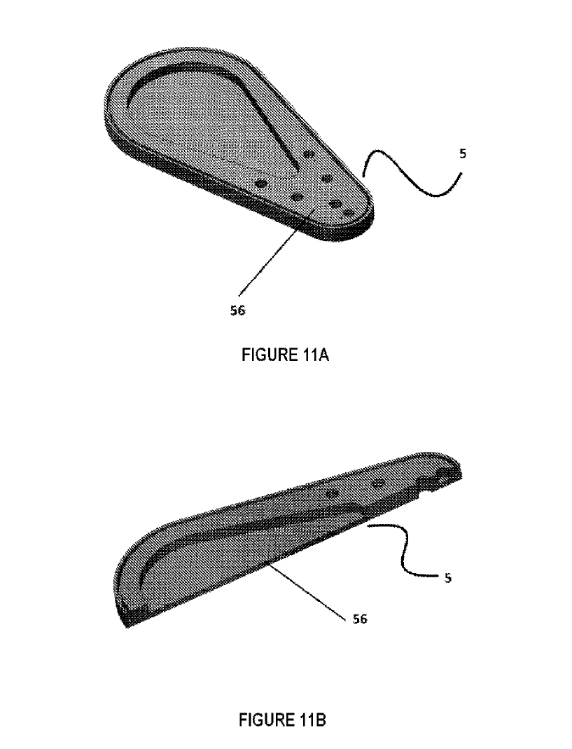

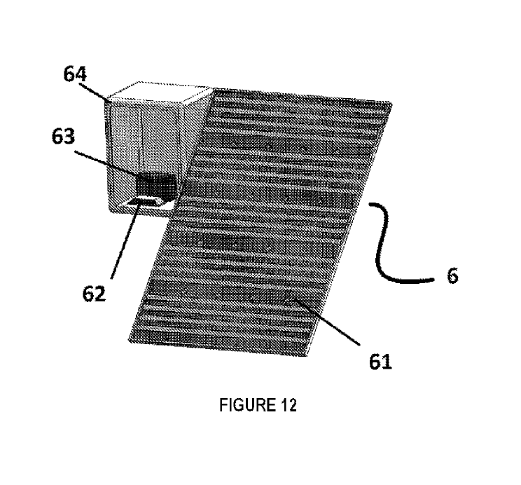

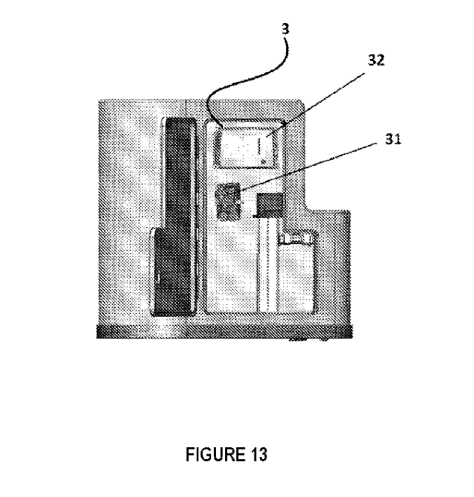

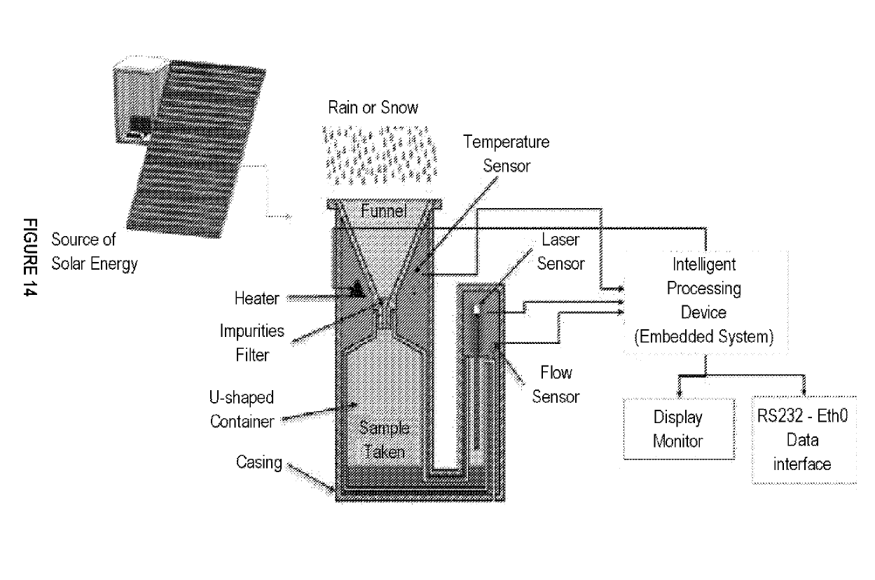

### DETAILED DESCRIPTION

The object of the present invention is to provide a system for measuring rain and snow, basically comprising:
module for collecting water or snow (1), the module for measuring the level and volume of fluid (2), the data processing and handling module (3), the heating module for collecting snow (4), housing (5) and a photovoltaic energy module (6).
A module for collecting water or snow (1), comprising a funnel (11), by means whereof the sample of rainwater is collected, an impurities filter (12) and a gasket (13) preventing water infiltrating within the interior of the housing (5).
A module for measuring the level and volume of fluid (2), comprising a laser sensor (21) measuring the height attained by the liquid, a laser sensor base (22), wherein there is affixed the laser sensor, for such purpose having in the interior thereof a perforation, three supports for the laser sensor (23) supporting the base and having as objective the maintenance of the sensor at the height of the measuring tube, three fixing rings for supports (24), a U-shaped bottle (25), wherein the sample is collected, a coupling for flow sensor (26), a flow sensor (27), a flow sensor outlet elbow (28), a drain tube (29), a protective filter for the drain (30).
A data processing module (3), comprising an embedded system (31) based upon the 32 bit processing architecture, possessing a power interface to control the heating module for collecting snow (4), a digital interface for display upon a liquid crystal or LED touch screen (32), an RS-232 communications interface, and an Ethernet 10/100/1000 communications interface.
A heating module for collecting snow (4), containing a conical resistance (41), the purpose whereof is to provide the appropriate temperature for the sample in order that the liquid be at the triple point (being the phase wherein the water is at the maximum density thereof), a conical support for the resistance (42) of ceramic material, a thermocouple temperature sensor (43) to be used to regulate the temperature of the resistance such that, in this manner, the appropriate temperature is transmitted to the sample for the measurement.
A housing (5), possessing a cover (51) to serve to isolate the electronic and control components of the system, a door (52) to permit access to the interior of the housing, a pin for the door (53), a locking device (54), two military connectors (55) for the RS-232, Ethernet and the supply voltage input connections, a base (56) possessing perforations appropriate for the support of the U-shaped bottle (25), the three fixing rings for supports (24) and the three supports for the laser sensor (23), a drain tube (29) and a protective filter for the drain (30).
A photovoltaic energy module (6), comprising a panel (61), a regulator (62), a battery (63), and an NEMA standard enclosure of type 4x (64).

The device for measuring rain and snow, which must be located outdoors in the zone whereat it is desired to measure the precipitation, wherein the water or the snow falls into the metal funnel (11) capable of conducting the temperature (preferably of aluminum, stainless steel or a non-oxidizing metal), possessing an impurities filter (12) preventing solid agents such as contaminants or insects ingressing into the device, the funnel (11) in turn rests upon a rubber gasket (13) preventing the filtration of water toward the interior of the housing (5). The funnel (11) rests upon the conical resistance (41) and the conical support for the resistance (42), these being responsible for maintaining the temperature in the funnel (11) in order to ensure that the fluid ingressing is at the correct temperature, through an adaptive control system, having as input the measurement from the thermocouple temperature sensor (43); this control system is implemented within the data processing module (3). The working temperature of the system or device of the present invention lies between temperatures as low as −80° C. up to temperatures of 40° C. An appropriate range is that wherein the temperature is equal to or exceeds 4° C. (degrees Celsius), preferably between 4° C. and 30° C., this being relevant during periods of cold in order to bring the water to the triple point and, in the case of periods of heat, it is considered that the ambient temperature of the location is adequate to measure the quantity of precipitation.

The U-shaped bottle (25) possesses two sections of different diameters joined by the bases thereof; the section of greater diameter is denominated inlet mouth, by virtue of the fact that it is through this section that the fluid is received, the section of lesser diameter being denominated outlet mouth, by virtue of the fact that in the case of heavy rain the fluid will be evacuated through same.

is The fluid is directed towards the U-shaped bottle (25); by virtue of the geometry and the hydrostatic paradox the level of liquid will be at the same height in the inlet mouth and in the outlet mouth. In the upper part of the outlet mouth is positioned a laser sensor (21) measuring the height attained by the liquid; in the particular case wherein the maximum quantity of liquid contained in the U-shaped bottle (25) is exceeded, the measurement of the precipitation is realized considering solely the measurement of the flow performed by means of the flow sensor (27) located between the outlet mouth and the drain.

The laser sensors (21) and the flow sensor (27) are connected to a data processor (3) which calculates the equivalent volume of outflowing water, in this manner achieving that the device may collect and measure any level of water no matter how high it may be.

This device possesses a data processing module (3) provided with artificial intelligence, comprising an embedded system (31) calculating and displaying graphs and data corresponding to the measurements of precipitation. This module permits a user to locally interact with and configure the device through the liquid crystal or LED touch screen (32).

The data processing module (3) possesses two communications interfaces, one RS-232 interface and one Ethernet interface, connected to the military connectors (55), permitting that the data measured may be transmitted to a remote location, rendering the device accessible.

The device for measuring rain and snow incorporates a photovoltaic energy module (6), by virtue whereof it may be installed in remote locations without complications of electrical installation.

The housing (5) is preferably manufactured from a thermosetting compound polymeric material, rendering it resistant to corrosion caused by changing climatic conditions. Each of the modules of the device are described below.

The present invention furthermore makes reference to the use of the system or device to measure any quantity of precipitation of rain or of snow.

Additionally, the present invention makes reference to the use of the system or device to measure the volume of fluid collected over time for the purpose of digitally recording the behavior of a precipitation.

Furthermore, the present invention concerns the use of the system or device to measure the precipitation of water or snow for aeronautical applications.

1. A system for measuring rain and snow comprising:
a module for collecting water or snow,
a module for measuring the level and volume of fluid,
a data processing and handling module,
a heating module for collecting snow,
a housing and a photovoltaic energy module,
wherein the module for collecting water or snow comprises a funnel, an impurities filter and a gasket, and the module for measuring the level and volume of fluid comprises a laser sensor, a laser sensor base, three supports for the laser sensor, three fixing rings for supports, a U-shaped bottle, a coupling for flow sensor, a flow sensor, a flow sensor outlet elbow, a drain tube and a protective filter for the drain, and the data processing module comprises an embedded system, a digital interface, an RS-232 communications interface, and an Ethernet 10/100/1000 communications interface.

2. The system for measuring rain and snow as claimed in claim 1, comprising a heating module for collecting snow containing a conical resistance, a conical support of ceramic material for the resistance and a thermocouple temperature sensor.

3. The system for measuring rain and snow as claimed in claim 1, wherein the housing possesses a cover, a door, a pin for the door, a locking device, two military connectors, a base, a drain tube and a protective filter for the drain.

4. The system for measuring rain and snow as claimed in claim 3, wherein the base posesses perforations for the support of the U-shaped bottle, the three fixing rings for supports and the three supports for the laser sensor.

5. The system for measuring rain and snow as claimed in claim 1, wherein the photovoltaic energy module comprises a panel, a regulator, a battery and an NEMA standard enclosure of type 4x.

6. (canceled)

7. (canceled)

8. (canceled)
